(19) United States
(12) Patent Application Publication
(10) Pub. No.: US 2024/0066745 A1
(43) Pub. Date: Feb. 29, 2024

(54) South Boston Toolworks Router Adapter

(71) Applicant: Kurt Michael Dobbins, Galion, OH (US)

(72) Inventor: Kurt Michael Dobbins, Galion, OH (US)

(21) Appl. No.: 18/458,846

(22) Filed: Aug. 30, 2023

Related U.S. Application Data
(60) Provisional application No. 63/373,942, filed on Aug. 30, 2022.

(51) Int. Cl. B27C 9/00; B25F 3/00; B27C 5/10; B27C 9/02

(52) U.S. Cl. CPC B27C 9/005; B25F 3/00; B27C 5/10; B27C 9/02

(57) ABSTRACT

The present invention is an inlay wood router adapter designed to easily convert a handheld rotary tool into a miniature precision wood router. The adapter can be used to precisely set the cutting depth, as well as provide finer control to the user. The adapter includes a cylindrical body and a head. The rotary tool is inserted into a bore hole of the cylindrical body. Once the rotary tool is properly positioned and the desired cutting depth is set, the user tightens a pair of set screws to lock the rotary tool in place. An exhaust port is routed through the cylindrical body, which can be used to direct pressurized air onto the work surface to clear away chipped material. A pair of beehive-shaped knobs are attached to the head. The pair of knobs allow the user to make precise movements while engraving or carving into a work surface.

### FIELD OF THE INVENTION

The present invention relates generally to adapters. More specifically the present invention is a wood router adapter capable of precisely setting the depth of which the cutter removes material.

### BACKGROUND OF THE INVENTION

Pneumatic pen grinders, otherwise known as pencil die grinders, are commonly used among craftsmen and artisans to make intricate cuts into wood, stone, or any other work surface. Most pen grinders have variable speed control, allowing the user to adjust the cutter speed setting. Due to their compact size, pen grinders are popular among woodworkers for engraving unique designs into wood surfaces. Unlike a standard wood router, pneumatic pen grinders are held like a pencil, giving the user more freedom to make precision cuts along the work surface.

The drawback to this increased mobility is that the user cannot set the cutting depth. Instead, the user must continually adjust the downward pressure of the cutter to ensure the cutting depth remains consistent throughout the routing path. This can be a tedious and challenging task when making multiple cuts and engravings on a single piece of wood. Thus, a need exists to develop a product that combines the precision and mobility of a pen grinder with the added capability of setting the cutting depth like a standard wood router.

It is an objective of the present invention to provide a solution to the aforementioned problem. The present invention is an inlay wood router adapter designed to easily convert a pneumatic pen grinder into a miniature precision wood router. The adapter fits around the pen grinder and allows the user to precisely set the depth of which the cutter removes the material. With this device, the user can focus more on the engraved design, rather than having to worry about maintaining a consistent cutting depth.

### SUMMARY

The present invention is an inlay wood router adapter. The adapter mechanically affixes a pneumatic pen grinder in place, effectively converting the pen grinder into a miniature precision wood router. It is an aim of the present invention to enhance the functionality of the pen grinder by allowing the user to precisely set the cutting depth of which the cutter removes material, as well as providing finer control to the user. The adapter comprises a handle and a head. The handle is in the form of a cylindrical body, with a bore hole that runs longitudinally through the center. The bore hole is sized to receive the pen grinder. The bell-shaped head is connected to the bottom of the handle.

To properly attach the adapter, the user first slides the pen grinder through the handle until the cutter reaches the desired cutting depth. The cutting depth is measured by how far the end of the cutter extends past the bottom of the head. Once set, the user can then tighten the pair of set screws positioned on the side of the handle to lock the pen grinder in place.

The handle further includes an exhaust port positioned next to the bore hole. The exhaust port is routed through the handle and exits out through the head. The user can attach a high-pressure hose to the top of the exhaust port so that pressurized air is routed through the handle and onto the work surface to clear away chipped material. The head has a pair of cutouts formed along the outer sidewall that act as viewing windows. This allows the user to see the cut being made. To control the movement of the adapter, a pair of brass knobs are attached to the outer sidewall of the head. Each knob is shaped in the form of a beehive, which provides superior handling over a traditional knob. The pair of knobs allows the user to make precise movements while engraving or carving into the work surface.

### BRIEF DESCRIPTION OF THE DRAWINGS

FIG. 1 is a top-front-left perspective view of the present invention, shown attached to a rotary tool.

FIG. 2 is a cutaway view taken from FIG. 1, showing the internal structure.

FIG. 3 is a bottom-rear-right perspective view of the present invention, shown attached to a rotary tool.

FIG. 4 is a cutaway view taken from FIG. 3, showing the internal structure.

FIG. 5 is a front elevational view of the present invention, shown attached to a rotary tool.

FIG. 6 is a top-front-left perspective view of the present invention.

FIG. 7 is a front elevational view of the present invention.

FIG. 8 is a front elevational cutaway view of the present invention.

FIG. 9 is a left-side elevational view of the present invention.

FIG. 10 is a left-side elevational cutaway view of the present invention.

FIG. 11 is a top plan view of the present invention.

FIG. 12 is a bottom plan view of the present invention.

### DETAIL DESCRIPTIONS OF THE INVENTION

All illustrations of the drawings are for the purpose of describing selected versions of the present invention and are not intended to limit the scope of the present invention.

Hereinafter, the term “rotary tool” refers to any handheld, electric or pneumatic power tool commonly used for cutting, polishing, sanding, deburring, or engraving a work surface (e.g., wood). Examples of rotary tools include but are not limited to pencil die grinders, pneumatic pen grinders, and electrically-powered rotary tools.

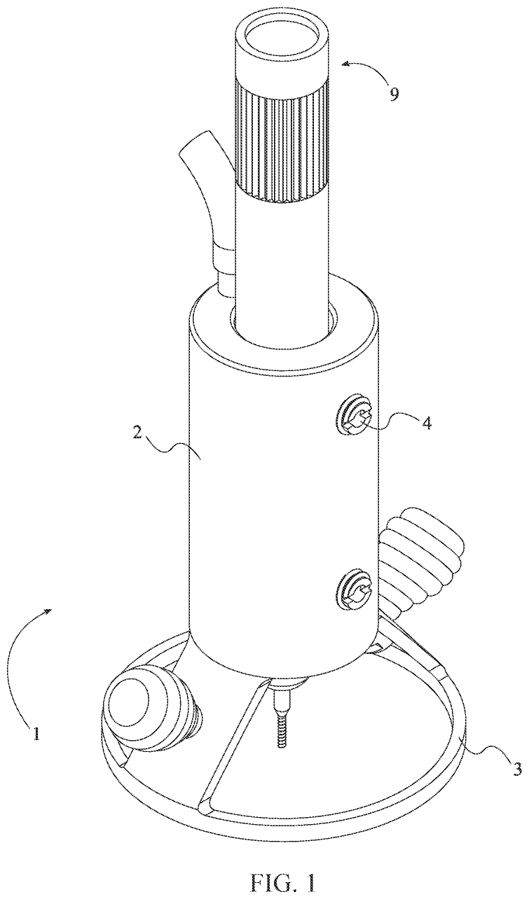

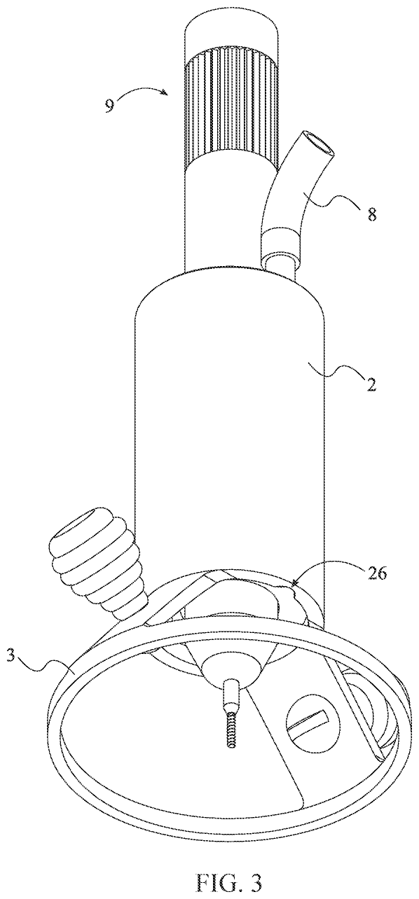

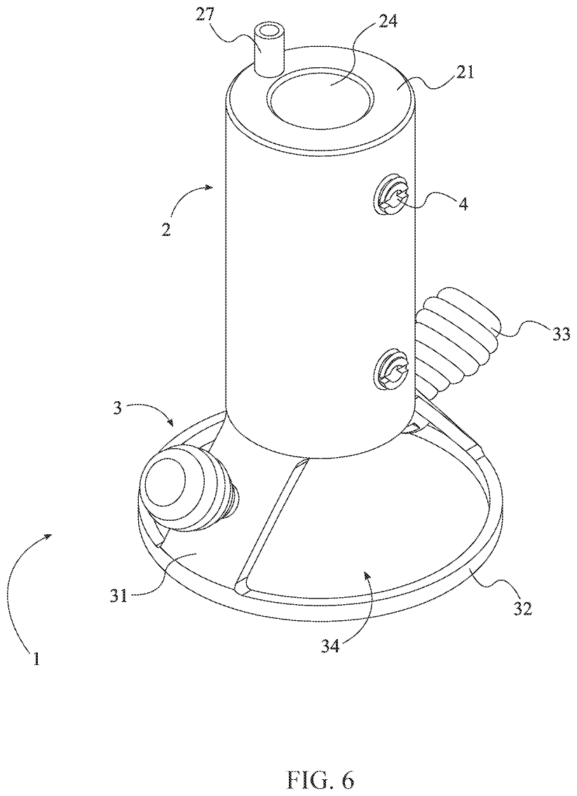

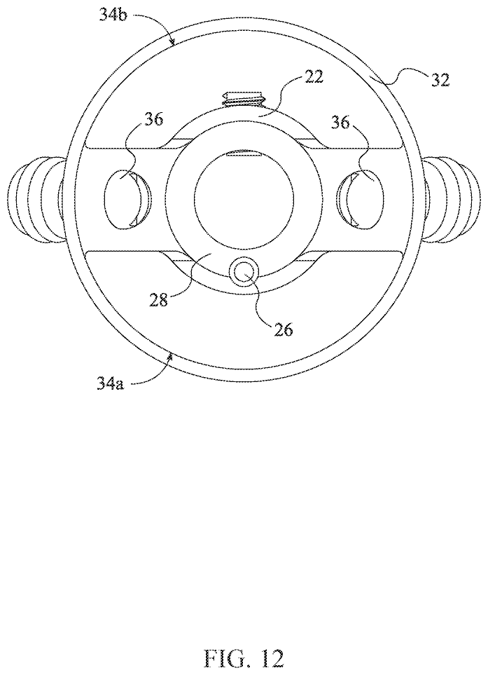

In reference to FIG. 1 through FIG. 5, the present invention is an inlay wood router adapter 1. The adapter 1 mechanically affixes a pneumatic pen grinder (rotary tool) in place, effectively converting the rotary tool 9 into a miniature precision wood router. It is an aim of the present invention to enhance the functionality of the rotary tool 9 by allowing the user to precisely set the cutting depth of which the cutter removes material, as well as providing finer control to the user. In reference to FIG. 6 through FIG. 12, the present invention comprises a cylindrical body 2, a head 3, and at least one set screw 4. The cylindrical body 2 is axially aligned with the head 3. Moreover, the head 3 is terminally connected to the bottom surface 22 of the cylindrical body 2 to form a single unitary piece. Preferably, the cylindrical body 2 and the head 3 are constructed from aluminum. However, the material of the cylindrical body 2 and the head 3 are not limited and can be made from any other suitable material.

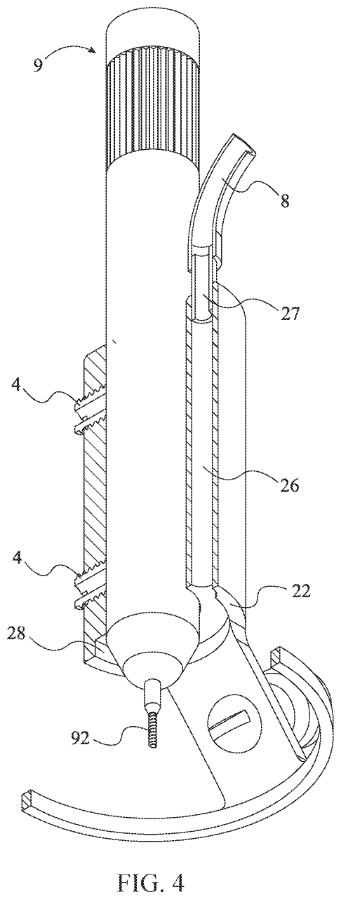

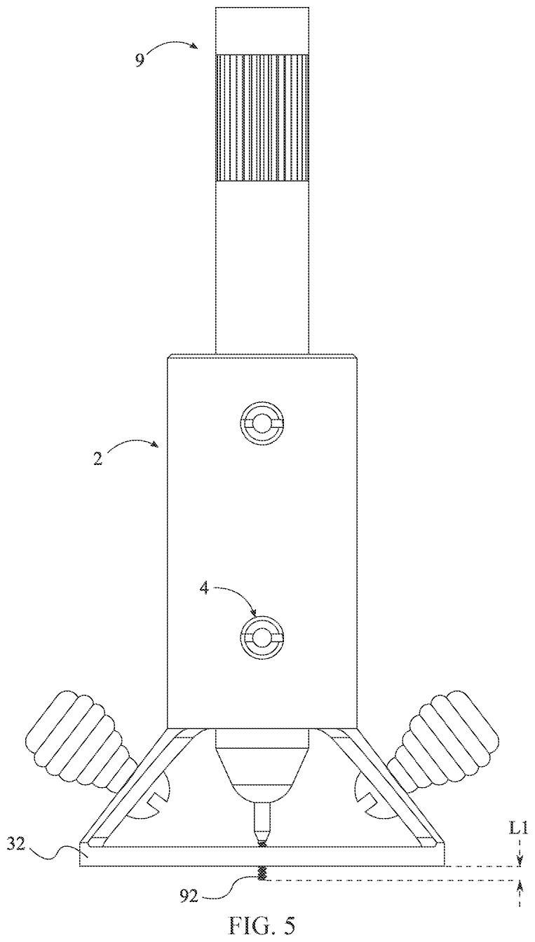

To use the present invention, the user begins by first inserting the rotary tool 9 through the bore hole 24 of the cylindrical body 2, and sliding the rotary tool 9 through until the cutter 92 reaches the desired cutting depth L1. Hereinafter, the cutting depth L1 is defined as the distance measured between the bottom of the head 3 and the tip of the cutter 92, as best seen in FIG. 5. Once the desired cutting depth L1 is set, the user tightens the at least one set screw 4 to secure the rotary tool 9 in place. As best seen in FIG. 4, a high-pressure hose 8 can be routed to the exhaust port 26, via a connector 27 located at the top of the cylindrical body 2. The exhaust port 26 guides a stream of pressurized air through the cylindrical body 2 and into the head 3. The stream of air is then directed to the work surface, which aids in clearing away chipped material, allowing the user to make precision cuts along a scribe. As best seen in FIG. 6, at least one knob 33 is attached to the outer sidewall 31 of the head 3. The at least one knob 33 is used as an ergonomic handle, providing finer control during the scribe. For enhanced visibility, the sidewall 31 has at least one cutout 34 that forms a viewing window. The viewing window gives the user a clear line of sight of the cutter 92 while cutting into the work surface.

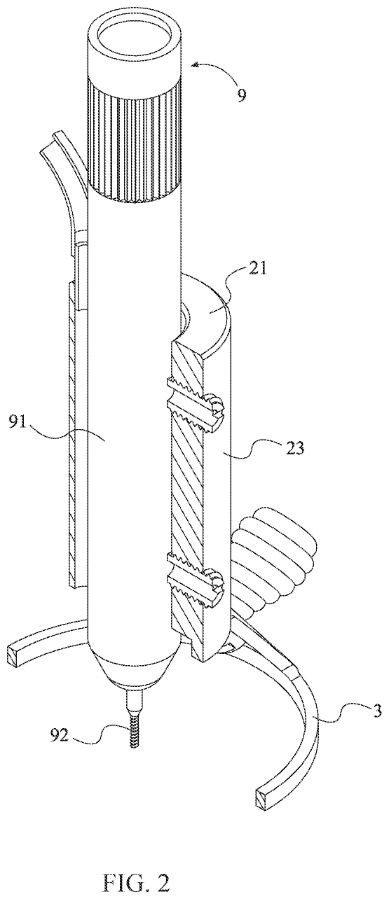

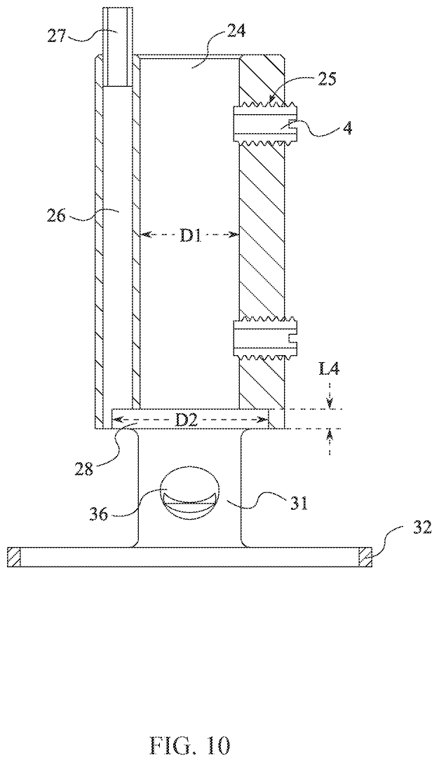

As can be seen in FIG. 6, the cylindrical body 2 functions as the primary structural component of the present invention, as the remaining components of the present invention are configured upon the cylindrical body 2. The cylindrical body 2 further comprises a top surface 21, a bottom surface 22, an outer surface 23, a bore hole 24, and at least one threaded aperture 25. The bore hole 24 is axially disposed on the top surface 21, traversing through the cylindrical body 2. The bore hole 24 has a bore hole diameter D1 defined by the rotary tool 9. Stated another way, the bore hole 24 is sized to match the handle 91 of the rotary tool 9, as seen in FIG. 2. This allows the rotary tool 9 to slidably engage with the bore hole 24, which in turn, allows the user to adjust the cutting depth L1. The at least one threaded aperture 25 is disposed on the outer surface 23 of the cylindrical body 2, traversing inward and intersecting the bore hole 24, as seen in FIG. 10. Thus, the at least one threaded aperture 25 is in communication with the bore hole 24. The at least one set screw 4 is configured to engage the at least one threaded aperture 25. Once the rotary tool 9 is properly positioned within the bore hole 24 and the cutting depth L1 is set, the user can then tighten down the at least one set screw 4 to lock the rotary tool 9 in place.

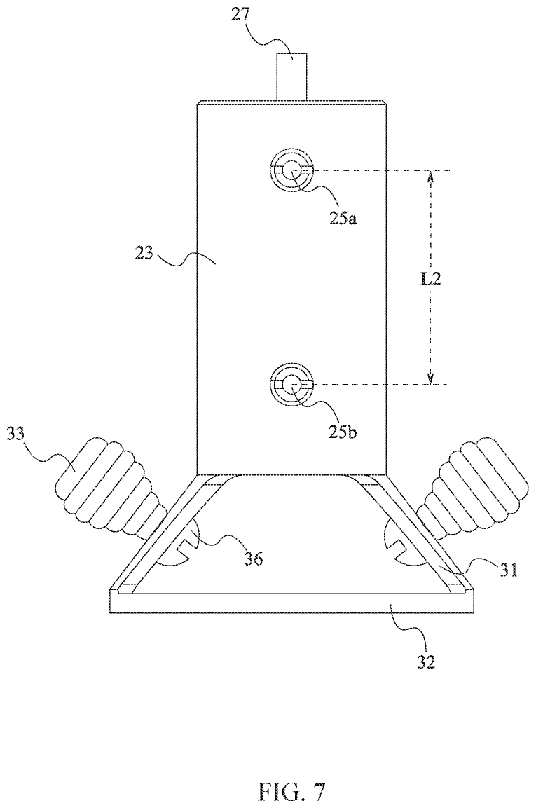

In a preferred embodiment, the cylindrical body 2 comprises an upper threaded aperture 25a and a lower threaded aperture 25b, as seen in FIG. 7. In this embodiment, the upper threaded aperture 25a is vertically aligned with the lower threaded aperture 25b. Moreover, the upper threaded aperture 25a is spaced apart from the lower threaded aperture 25b by a predefined gap L2. This arrangement increases the clamping force, ensuring the rotary tool 9 does not shift or slide out of position during use.

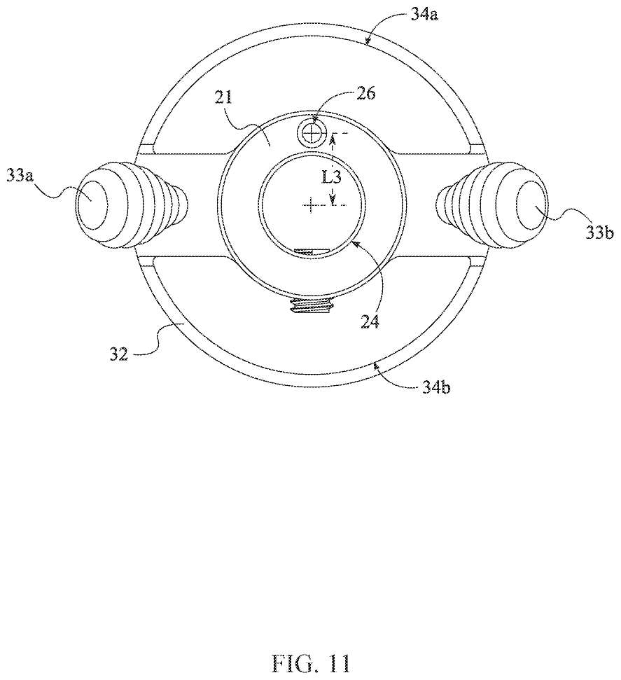

Continuing with the preferred embodiment, the cylindrical body 2 further comprises an exhaust port 26, a connector 27, and a bottom opening 28. As best seen in FIGS. 10 and 11, the exhaust port 26 is disposed on the top surface 21 of the cylindrical body 2, traversing through the bottom surface 22. Preferably, the exhaust port 26 is positioned offset from the bore hole 24 by a predefined distance L3, and located opposite of the at least one threaded aperture 25. The connector 27 is press fitted into the exhaust port 26 at the top surface 21 of the cylindrical body 2, such that a portion of the connector 27 protrudes above the top surface 21. Preferably, the connector 27 is a piece of copper tubing. However, the shape of the connector 27 is not limited and may take the form of any other suitable component. A high-pressure hose 8 can be attached to the connector 27, which directs incoming air to pass through the cylindrical body 2 and onto the work surface to clear away chipped material. The bottom opening 28 is axially disposed on the bottom surface 22 of the cylindrical body 2, traversing longitudinally at a predefined distance L4. As can be seen in FIG. 10, the bottom opening 28 has a diameter D2 that is larger than the bore hole diameter D1, such that the bottom opening 28 partially traverses into the bottom of the exhaust port 26. In this arrangement, the bottom opening 28 further aids in guiding the flow of air onto the work surface.

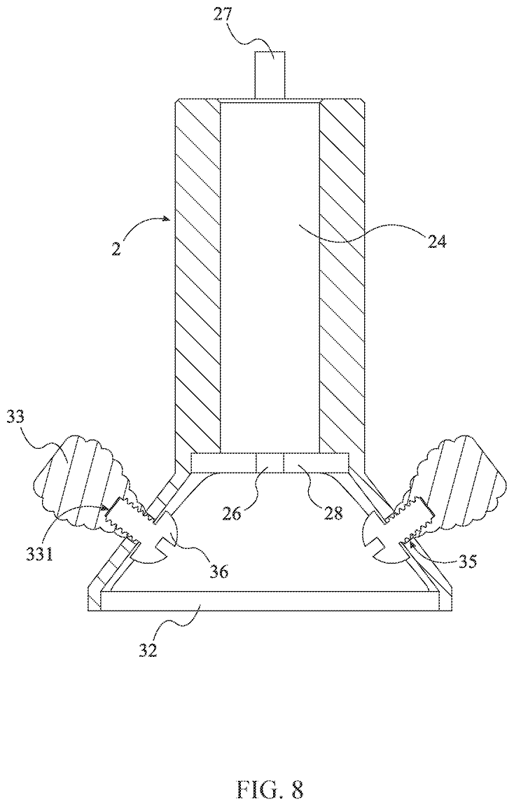

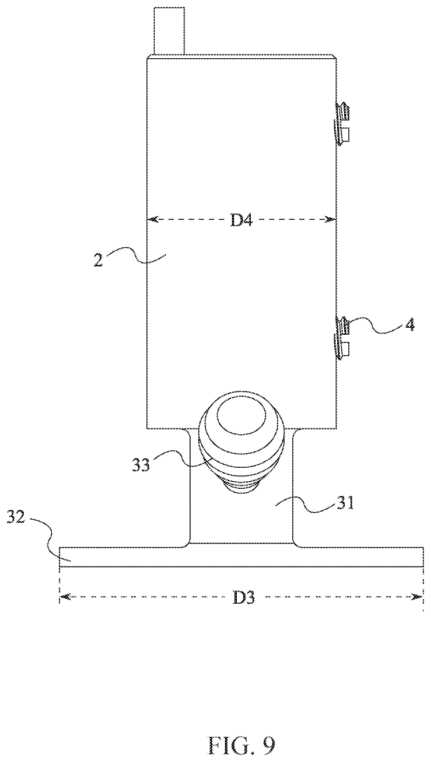

The head 3 further comprises a sidewall 31, an annular flange 32, and at least one knob 33. As best seen in FIG. 8, the sidewall 31 is perimetrically attached the bottom surface 22 of the cylindrical body 2, extending longitudinally to the annular flange 32. The at least one knob 33 is positioned on the sidewall 31, extending outward. The at least one knob 33 allows the user to make precise movements of the adapter 1 along the routing path. As seen in FIG. 9, the annular flange 32 has a diameter D3 that is larger than the cylindrical body diameter D4, thereby creating a large stable platform for the head 3 to rest on the work surface.

In the preferred embodiment, the head 3 further comprises at least one cutout 34 disposed on the sidewall 31. As can be seen in FIG. 6, the cutout 34 functions as a viewing window, giving the user a clear line of sight of the cutter 92 while routing the work surface. Thus, the user can monitor the routing path in real time without having to remove the adapter 1 from the work surface. Preferably, as best seen in FIG. 11, the present invention comprises a pair of cutouts 34a and 34b positioned opposite of each other on the sidewall 31. The pair of cutouts 34a and 34b gives the user a clear line of sight from both sides of the head 3, while still retaining portions of the sidewall 31 for structural integrity.

Continuing with the preferred embodiment, the at least one knob 33 is shaped in the form of a beehive. The beehive shape provides an ergonomic grip for making precise movements of the adapter 1. As best seen in FIG. 8, the at least one knob 33 is detachably mounted to the head 3 via at least one fastener 36. In this embodiment, the at least one knob 33 has a threaded opening 331 on the proximal end. The sidewall 31 has at least one mounting hole 35 positioned over the at least one knob 33. The at least one fastener 36 is configured to be inserted through the at least one mounting hole 35 and fastened into the threaded opening 331 of the at least one knob 33. Preferably, the head 3 comprises a pair of knobs 33a and 33b positioned opposite of each other on the sidewall 31. This arrangement provides improved handling of the adapter 1 during use. It is understood that the means of attaching the at least one knob 33 to the sidewall 31 is not limited to fasteners, and can be attached by any other suitable means, including but not limited to adhesive bonding and welding.

Although the invention has been explained in relation to its preferred embodiment, it is to be understood that many other possible modifications and variations can be made without departing from the spirit and scope of the invention.

What is claimed is:

1. An adapter for a handheld rotary tool, the adapter comprising:
a cylindrical body;
a head;
at least one set screw;
the cylindrical body comprising a top surface, a bottom surface, an outer surface; a bore hole, and at least one threaded aperture;
the bore hole being axially disposed on the top surface;
the at least one threaded aperture being disposed on the outer surface;
the at least one threaded aperture traversing laterally into the bore hole;
the head being terminally connected to the bottom surface of the cylindrical body;
the bore hole being defined by a rotary tool, such that the rotary tool is capable of slidably engaging with the bore hole;
the at least one set screw being configured to engage the at least one threaded aperture; and
the at least one set screw being configured to lock the rotary tool in place along the bore hole.

2. The adapter as claimed in claim 1 comprising:
the cylindrical body further comprising an exhaust port;
the exhaust port being disposed on the top surface, adjacent to the bore hole;
the exhaust port traversing longitudinally through the bottom surface; and
the exhaust port capable of directing pressurized air through the cylindrical body and into the head.

3. The adapter as claimed in claim 2 comprising:
the cylindrical body further comprising a bottom opening;
the bottom opening being axially disposed on the bottom surface; and
the bottom opening being larger diameter-wise than the bore hole.

4. The adapter as claimed in claim 1 comprising:
the head comprising a sidewall and an annular flange;
the sidewall extending perimetrically from the bottom surface of the cylindrical body to the annular flange; and
the annular flange being larger diameter-wise than the cylindrical body.

5. The adapter as claimed in claim 4 comprising:
the head further comprising at least one cutout;
the at least one cutout being disposed on the sidewall; and
the at least one cutout forming a viewing window.

6. The adapter as claimed in claim 4 comprising:
the head further comprising at least one knob; and
the at least one knob being positioned on the sidewall, extending outward.

7. The adapter as claimed in claim 6 comprising:
the head further comprising at least one fastener and at least one mounting hole;
the at least one mounting hole being disposed on the sidewall;
the at least one knob having a threaded opening;
the at least one fastener being configured to engage the threaded opening; and
the at least one fastener being inserted through the at least one mounting hole and into the threaded opening of the at least one knob.

8. The adapter as claimed in claim 6, wherein the at least one knob being in the shape of a beehive.

9. An adapter for a handheld rotary tool, the adapter comprising:
a cylindrical body;
a head;
at least one set screw;
the cylindrical body comprising a top surface, a bottom surface, an outer surface; a bore hole, and at least one threaded aperture;
the bore hole being axially disposed on the top surface;
the at least one threaded aperture being disposed on the outer surface;
the at least one threaded aperture traversing laterally into the bore hole;
the head being terminally connected to the bottom surface of the cylindrical body;
the head comprising a sidewall and an annular flange;
the sidewall extending perimetrically from the bottom surface of the cylindrical body to the annular flange;
the annular flange being larger diameter-wise than the cylindrical body;
the bore hole being defined by a rotary tool, such that the rotary tool is capable of slidably engaging with the bore hole;
the at least one set screw being configured to engage the at least one threaded aperture; and
the at least one set screw being configured to lock the rotary tool in place along the bore hole.

10. The adapter as claimed in claim 9 comprising:
the cylindrical body further comprising an exhaust port;
the exhaust port being disposed on the top surface, adjacent to the bore hole;
the exhaust port traversing longitudinally through the bottom surface; and
the exhaust port capable of directing pressurized air through the cylindrical body and into the head.

11. The adapter as claimed in claim 10 comprising:
the cylindrical body further comprising a bottom opening;
the bottom opening being axially disposed on the bottom surface; and
the bottom opening being larger diameter-wise than the bore hole.

12. The adapter as claimed in claim 9 comprising:
the head further comprising at least one cutout;
the at least one cutout being disposed on the sidewall; and
the at least one cutout forming a viewing window.

13. The adapter as claimed in claim 9 comprising:
the head further comprising at least one knob; and
the at least one knob being positioned on the sidewall, extending outward.

14. The adapter as claimed in claim 13 comprising:
the head further comprising at least one fastener and at least one mounting hole;
the at least one mounting hole being disposed on the sidewall;
the at least one knob having a threaded opening;
the at least one fastener being configured to engage the threaded opening; and
the at least one fastener being inserted through the at least one mounting hole and into the threaded opening of the at least one knob.

15. The adapter as claimed in claim 13, wherein the at least one knob being in the shape of a beehive.

16. An adapter for a handheld rotary tool, the adapter comprising:
a cylindrical body;
a head;
at least one set screw;
the cylindrical body comprising a top surface, a bottom surface, an outer surface; a bore hole, at least one threaded aperture, and an exhaust port;
the bore hole being axially disposed on the top surface;
the at least one threaded aperture being disposed on the outer surface;
the at least one threaded aperture traversing laterally into the bore hole;
the exhaust port being disposed on the top surface, adjacent to the bore hole;
the exhaust port traversing longitudinally through the bottom surface;
the exhaust port capable of directing pressurized air through the cylindrical body and into the head;
the head being terminally connected to the bottom surface of the cylindrical body;
the head comprising a sidewall and an annular flange;
the sidewall extending perimetrically from the bottom surface of the cylindrical body to the annular flange;
the annular flange being larger diameter-wise than the cylindrical body;
the bore hole being defined by a rotary tool, such that the rotary tool is capable of slidably engaging with the bore hole;
the at least one set screw being configured to engage the at least one threaded aperture; and
the at least one set screw being configured to lock the rotary tool in place along the bore hole.

17. The adapter as claimed in claim 16 comprising:
the cylindrical body further comprising a bottom opening;
the bottom opening being axially disposed on the bottom surface; and
the bottom opening being larger diameter-wise than the bore hole.

18. The adapter as claimed in claim 16 comprising:
the head further comprising at least one cutout;
the at least one cutout being disposed on the sidewall; and
the at least one cutout forming a viewing window.

19. The adapter as claimed in claim 16 comprising:
the head further comprising at least one knob; and
the at least one knob being positioned on the sidewall, extending outward.

20. The adapter as claimed in claim 19 comprising:
the head further comprising at least one fastener and at least one mounting hole;
the at least one mounting hole being disposed on the sidewall;
the at least one knob having a threaded opening;
the at least one fastener being configured to engage the threaded opening;
the at least one fastener being inserted through the at least one mounting hole and into the threaded opening of the at least one knob; and
the at least one knob being in the shape of a beehive.
